(19) United States
(12) Patent Application Publication
(10) Pub. No.: US 2026/0118665 A1
(43) Pub. Date: Apr. 30, 2026

(54) SLIP DETECTION FOR HEAD-MOUNTED ELECTRONIC DEVICES

(71) Applicant: Apple Inc., Cupertino, CA (US)

(72) Inventors: Tong Chen, Fremont, CA (US); David D. Dashevsky, San Jose, CA (US); Sriram Moorthy, San Jose, CA (US); Yongkang Gao, Sunnyvale, CA (US)

(21) Appl. No.: 19/295,535

(22) Filed: Aug. 8, 2025

Related U.S. Application Data
(60) Provisional application No. 63/699,495, filed on Sep. 26, 2024.

(51) Int. Cl. G02B 27/00; G02B 27/01

(52) U.S. Cl. CPC G02B 27/0093; G02B 27/0172; G02B 27/0176; G02B 2027/0138; G02B 2027/014; G02B 2027/0178

(57) ABSTRACT

A relative position change sensor includes a laser element and an image sensor. The relative position change sensor is disposed within a nose pad of a head-mounted electronic device so that the laser element is positioned to emit laser light against a substantially stationary portion of the wearer's anatomy, such as a side of the nasal bone of the wearer. As a result of this construction and orientation, the image sensor is configured to be illuminated with a laser speckle pattern that may shift in plane proportional to movement between the substantially stationary portion and the head-mounted electronic device. Upon determining such a shift has occurred, the relative position change sensor may report a slippage event in respect of the head-mounted electronic device and the wearer.

### CROSS REFERENCE TO RELATED APPLICATION

This application is a nonprovisional of, and claims the benefit under 35 U.S.C. § 119(e) of U.S. Provisional Patent Application No. 63/699,495, filed on Sep. 26, 2024, the contents of which are incorporated herein by reference as if fully disclosed herein.

### TECHNICAL FIELD

Embodiments described herein relate to head-mounted electronic devices, and in particular to systems and methods supporting low-power and low-latency device slip detection and measurement.

### BACKGROUND

A head-mounted device can include a frame that positions a display or other electronics with respect to a user's field of view. The frame can be supported by the wearer's anatomy. For example, a portion of the frame may rest between the ear and temporal scalp and another portion of the frame may rest over the nasal bone, in a manner similar to eyeglasses or goggles.

Some head-mounted devices generate an immersive experience for a wearer by monitoring eye position, gaze, and/or fixation(s) to adjust output of a display, such as focus, position, depth, and the like, in near real time. For these devices, an accurate determination of relative spatial position between the wearer's eyes and the display itself is critical because even slight misalignments or positional error may be noticeable to the wearer. Problematically, as a wearer moves, many devices tend to shift or slip relative to the wearer's anatomy, unpredictably changing the precision and/or accuracy of previous calculations or assumptions of relative spatial position of the device and the wearer.

Conventional head-mounted devices attempt to address this problem in primarily two ways. For example, some conventional devices require fastening straps or other securing hardware to immobilize the device relative to the wearer. Other devices operate high resolution and high frame rate imaging systems that constantly monitor wearer anatomy. Such constantly monitoring systems (1) require significant power, memory, processing, and imaging resources that may not be suitable for small form factor or battery-powered applications and (2) increase device mass in a manner that exacerbates slippage risk. Furthermore, implementations based on imaging systems may exhibit latency that may be noticeable to a user.

### SUMMARY

Embodiments described herein relate to a relative position change sensor for a head-mounted device. The relative position change sensor includes a laser element and an imaging system positioned apart from the laser element. The imaging system may be a complementary metal oxide semiconductor (“CMOS”) imaging array, a single photon avalanche diode (“SPAD”) array, an array of photodiodes, or any other suitable imaging component or system of components.

The imaging system may be configured to positionally track, in two dimensions (and/or rotations along one or more axes perpendicular to those dimensions), flow of one or more pixels of a speckle pattern reflected from a skin surface of a wearer of the head-mounted device. As a result of this architecture, the speckle pattern shifts in plane by an amount that corresponds to a change in position of the imaging target (e.g., the skin surface) relative to the head-mounted device. Thus, by monitoring changes in the speckle pattern (e.g., speckle flow) in lieu of measuring changes in focused pixels (e.g., optical flow), the relative position change sensor output may be operated in manner that is substantially agnostic to wearer-specific skin characteristics, topology, features, and/or absolute position of the wearer relative to the head-mounted device.

In many cases, the imaging system can be operationally coupled to a controller or processor that is configured to calculate a magnitude and direction of relative shift, rotation, or other positional change in respect of sequential different frames captured by the imaging system. This output can thereafter be used to determine magnitude of shift in two or more dimensions defined with reference to a static origin point used to calculate relative position of the wearer's anatomy and the head-mounted device.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a user wearing a head-mounted electronic device that can incorporate a slippage sensing system as described herein.

FIG. 2A depicts a user wearing a head-mounted electronic device that can incorporate a slippage sensing system as described herein.

FIG. 2B depicts a front plan view of the head-mounted electronic device of FIG. 2A, including a detail section A-A.

FIG. 2C depicts a side plan view of the head-mounted electronic device of FIG. 2A.

FIG. 3 is a simplified diagram of a slippage sensing system as described herein.

FIG. 4 is a system diagram of the slippage sensing system of FIG. 3.

FIG. 5 is a flowchart depicting example operations of a method of operating a slippage sensing system in a first mode, as described herein.

FIG. 6 is a flowchart depicting example operations of a method of operating a slippage sensing system in a second mode, as described herein.

FIG. 7 is a flowchart depicting example operations of a method of operating a slippage sensing system in a third mode, as described herein.

The use of the same or similar reference numerals in different figures indicates similar, related, or identical items.

Certain accompanying figures include vectors, rays, traces and/or other visual representations of one or more example paths-which may include reflections, refractions, diffractions, and so on, through one or more media—that may be taken by, or may be presented to represent, one or more photons, wavelets, or other propagating electromagnetic energy originating from, or generated by, one or more light sources shown or, or in some cases, omitted from, the accompanying figures. It is understood that these simplified visual representations of light or, more generally, electromagnetic energy, regardless of spectrum (e.g., ultraviolet, visible light, infrared, and so on), are provided merely to facilitate an understanding of the various embodiments described herein and, accordingly, may not necessarily be presented or illustrated to scale or with angular precision or accuracy, and, as such, are not intended to indicate any preference or requirement for an illustrated embodiment to receive, emit, reflect, refract, focus, and/or diffract light at any particular illustrated angle, orientation, polarization, color, or direction, to the exclusion of other embodiments described or referenced herein.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to head-mounted electronic devices. A head-mounted electronic device may take the form factor of, for example, monocles, eyeglasses, goggles, or a head-mounted display (HMD), and may be configured to be worn by a user (the “wearer”) over at least one eye. As a result of this arrangement, a display or projector of the head-mounted electronic device can be used to render an image that can include information and/or content, such as an extended reality environment, for the wearer.

As used herein, an “extended reality environment” refers to a wholly or partially simulated environment that a user may perceive and/or interact with using a head-mounted electronic device as described herein. In some instances, an extended reality environment may be a visually simulated environment in which the wearer's physical environment is entirely replaced with virtual content within a virtual reality environment. The virtual reality environment may not be dependent on the wearer's physical environment, and may allow the wearer to perceive that the wearer is in a different, simulated location. The virtual reality environment may include virtual objects with which the user may interact.

In other instances, an extended reality environment may be a mixed reality environment, a partially simulated environment in which a wearer may view virtual content along with a portion of the wearer's physical environment. Specifically, a mixed reality environment may allow a wearer to perceive aspects of their physical environment, either directly or indirectly. In this way, the wearer may perceive (directly or indirectly) their physical environment through the mixed reality environment, while also still perceiving the virtual content.

In yet other examples, an extended reality environment may be an augmented reality environment in which one or more objects or content items are rendered in virtual physical locations within the wearer's physical environment.

Broadly, in view of the foregoing, an extended reality environment as described herein can include a portion of a physical environment, a portion of a virtual environment, a portion of a physical object, a portion of a virtual object, or any combination thereof.

To present virtual environments or objects to a user, a head-mounted electronic device can include a transparent, translucent or opaque display or projection system, collectively referred to as a “display.”

A head-mounted electronic device can include a frame—also referred to as a housing or enclosure—that can be configured to rest on and/or otherwise engage with the wearer's anatomy, such as the wearer's ears and/or nasal bone. Frame geometry can vary from embodiment to embodiment, but in many cases, may be configured to at least partially rest on the wearer's ear(s) and nasal bone, in a manner similar to eyeglasses. In some cases, the frame may be supported at least in part by other contact points with the wearer's anatomy, such as over the brow, cheeks, or with a portion (e.g., a strap) configured to a engage with at least a portion of occipital bone.

The frame of a head-mounted electronic device as described herein can enclose and/or support a display (or projector) as described above that serves as a portion of an image generation system. In some cases, a projector may be disposed within a wearer-facing portion of the frame and oriented to project an image onto a surface visible to the wearer, such as an interior surface of a lens positioned over the wearer's eye. In other cases, a physical transparent, translucent, or opaque display can be disposed within or on a lens, positioned in front of the wearer's eye.

It may be appreciated that many constructions are possible; regardless of the form factor of a particular embodiment, it may be appreciated that a head-mounted electronic device as described herein can be configured to present an image to a wearer thereof by operation of an image generation system that includes at least one type of display (and associated control electronics, optical elements, power supplies, and the like).

In many cases, a head-mounted electronic device can also include an eye tracking system or sensor array oriented toward the wearer's eyes and configured to track and/or estimate positions of the wearer's eyes, pupils, or other eye geometry. Specifically, the eye tracking system can be configured to determine, calculate, predict, or otherwise infer a gaze direction, fixation point, focal point or any other suitable characteristic of the wearer's eyes at a given instance.

Output of an eye tracking system can be used to inform rendering of images for the wearer; the images may be associated with a virtual environment, a virtual object, or any other aspect of an extended reality experience as described herein. For example, in some embodiments, a head-mounted electronic device can be configured and operated to generate a unique image for each eye (e.g., via multiple displays or multiple projectors). In these examples, content rendered in each image can be positioned and oriented to induce a perspective effect for the wearer. More simply, different (but geometrically related) images can be presented to each eye, such that when simultaneously viewed and focused upon by the wearer, a single three-dimensional object or content item may be perceived as having certain dimensions and perceived as being positioned at a particular distance from the wearer within a virtual environment or within the wearer's physical environment. The perceived distance may be based, at least in part, on the relative position of and orientation objects within each respective eye-specific image.

In these and related examples, the eye tracking system can be used to modify right-eye and/or left-eye rendered images in real time, based on the position of each eye. As the user's focus distance and/or fixation point changes—as trigonometrically inferred by the eye tracking system based on the determined position of the wearer's eyes relative to the display of the head-mounted electronic device—different objects and/or different perspectives may be rendered, brought into or out of focus, or the like.

Another example use for an eye tracking system of a head-mounted electronic device may be to support foveated rendering techniques in which portions of an image are rendered at higher or lower resolution depending upon the wearer's focus or fixation. If a wearer is not focused at a particular virtual object rendered by the head-mounted electronic device, that object may be rendered with lower resolution than an object commanding the wearer's focus. As the wearer changes focus—as determined by the eye tracking system—different objects can be rendered at different frame rates, different resolutions, and the like. As may be appreciated foveated rendering techniques can reduce overall processing load associated with rendering an extended virtual environment as described herein.

For simplicity of description and illustration, many embodiments that follow reference foveated rendering as an example use case of eye tracking system output; it may be appreciated that this is merely one example use case for eye tracking systems of head-mounted electronic devices.

In view of the foregoing, it may be appreciated that regardless of implementation, form factor, or application it may be advantageous to include an eye tracking system to support, as one example, foveated rendering within a head-mounted electronic device to improve wearer experience and/or enrich wearer experience.

Generally and broadly, an eye tracking system may be configured to include one or more cameras configured to capture sequential image frames of the wearer's eyes, perform one or more image analysis operations to determine feature locations (e.g., pixel locations and movement frame to frame) and/or velocity, and perform calculations to determine a gaze direction of a single eye, and/or where that gaze intersects an image displayed for the wearer before that respective eye. Thereafter, calculated gaze direction(s) of both eyes can be combined to determine an approximate focal distance and/or fixation point, relative to a coordinate system defined in respect of a virtual volume or a physical volume or a combination thereof.

It may be appreciated, however, that despite all the advantages of an eye tracking system, a significant number of calculations necessary for the operation of the eye tracking system are based on and indeed entirely reliant upon a fixed reference point of some coordinate system. More simply, conventional eye tracking systems are configured to assume a static relative position of the wearer and the head-mounted electronic device itself. In other words, an eye tracking system is configured—for, in many cases, computational economy and/or latency reduction reasons—to presume that any change in eye position identified between successive frames captured by an image sensor is exclusively due to movement of the wearer's eye, and not due to any shift or slip of the head-mounted electronic device itself, relative to the wearer.

More simply, conventional eye tracking systems are typically not able to reliably and quickly distinguish a wearer moving an eye to the left from an inadvertent translation of the head-mounted electronic device to the right. Similarly, conventional eye tracking systems are typically not able to reliably and quickly distinguish a wearer moving an eye upwards from the head-mounted electronic device slipping down the wearer's nose.

As a result, eye tracking accuracy—which is based on the presumption of a fixed relative position between the wearer and the device—can drift or change over time, as a head-mounted electronic device shifts, repositions, or moves with the wearer. In these examples, because in large part eye position errors are scaled when calculating gaze direction over large distance, images generated by the head-mounted electronic device (based on data from the eye tracking system) may be likewise rendered inaccurately or imprecisely, and may appear confusing, unrealistic, frustrating, or uncomfortable to the wearer.

For example, as noted above, many head-mounted electronic devices are configured for foveated rendering. In these example, if an eye tracking system inaccurately determines the wearer's eye position(s), determinations of what objects or regions of a virtual environment to render with high resolution or low resolution may be inaccurate, delayed, or otherwise misaligned from natural wearer expectations. In an example, as a wearer surveys a virtual scene, gaze may change rapidly. If the head-mounted electronic device has shifted, even slightly, from a previously-calculated presumed relative position, the calculated gaze direction will be incorrect for one or both eyes. As a result, objects that the user intends to fixate upon may be blurred, rendered at low resolution, or otherwise sub-optimally presented. These effects reduce the quality of the wearer's experience, and in some case can induce nausea or feelings of vertigo.

In view of the foregoing, it may be appreciated that generally and broadly, certain head-mounted electronic devices include eye tracking systems, which inherently depend upon a presumption that differences between frames is attributable only to a wearer's eye movement. This assumption introduces significant performance and experience degradation if a head-mounted electronic device slips down a wearer's nose, pulls away from the wearer's face, or draws closer to the wearer's face. This problem may be referred to as the “slippage” problem with eye-tracking head-mounted electronic devices.

Conventional solutions to the “slippage” problem with eye-tracking head-mounted electronic devices typically introduce tighter attachment to the wearer's anatomy (e.g., via straps, more contact points, and so on) and/or more frequent recalculation/re-estimation of relative position between the device and wearer. The first solution is often uncomfortable for a wearer, especially over long periods of time. The second solution is often not feasible for battery powered head-mounted electronic devices. Further, the second solution often introduces significant additional latency, which can further reduce the quality of the wearer's experience of wearing the head-mounted electronic device.

To address these and other problems with conventional head-mounted electronic devices, the embodiments described herein include a low-power and low-latency slippage sensing system that includes a relative position change sensor. The relative position change sensor includes a laser element, an image sensor, and a processor or controller. The laser element can be positioned to reflect from a skin surface of the wearer. The image sensor, offset by a distance from the laser element, can receive a speckle pattern. In another phrasing, the image sensor does not receive a focused image of the skin surface of the wearer, rather, the image sensor is illuminated by a speckle pattern. As used herein, the phrase “speckle pattern” refers to a granular, random interference pattern resulting from coherent laser light (emitted form the laser element) reflects from a rough or irregular surface (the skin surface).

As a result of this architecture, pixels of an image generated by the image sensor correspond to portions of the speckle pattern and can be analyzed by the processor to determine direction and/or velocity of each pixel, a subset of pixels, or an average of all pixels or a group of pixels. Such a determination may be referred to herein a determining “flow” of the speckle pattern.

Detecting the flow (e.g., velocity, direction, and/or rotation) of a speckle pattern across an imaging plane of the image sensor can be used to determine whether a shift between the skin surface and the relative position change sensor has occurred between measurements or frames captured by the image sensor. If a change is detected, a magnitude of that change can be correlated (e.g., scaled) to a corresponding direction and magnitude of shift between the head-mounted electronic device and the wearer's anatomy.

The embodiments described herein can leverage speckle flow sensing to reliably detect relative position changes between a wearer and a head-mounted electronic device by positioning the relative position change sensor to illuminate a typically stationary anatomical feature of the wearer, such as skin over the sides of the nasal bone, the glabella (or there above), or the temples. For example, in many embodiments, the relative position change sensor can be disposed in, within, or adjacent to a nose pad portion of the frame of the head-mounted electronic device. As a result of this placement, the relative position change sensor illuminates, from a distance, a portion of the wearer's skin that is unlikely to significantly move relative to the head-mounted electronic device, unless the entire device has shifted its position relative to the user.

More specifically, because the mass of the head-mounted electronic device is supported at least in part by nose pad, the nose pad in this configuration serves to pull taught and/or partially immobilize or support adjacent tissue. By positioning the relative position change sensor to illuminate this skin area, the relative position change sensor will observe a large-magnitude shift in speckle pattern (e.g., a nonzero speckle pattern flow) substantially only in response to a slippage event in which the device physically moves relative to the wearer's nose bridge. In this manner, the relative position change sensor can be used as a low-power and low-latency indicator that a shift has occurred.

However, it may be appreciated that because the relative position change sensor leverages laser speckle flow sensing in lieu of optical flow sensing or another sensing modality, the amount of shift detected by the image sensor can be directly correlated to an amount of actual shift between the device and the wearer. In some cases, detected movement may be 1:1 correlated with actual device movement. In other cases, another scaling factor may be used.

It may be appreciated that optical flow sensing results in a displacement estimation that is entirely dependent on distance to an object in focus that has been recognized as moving within the field of view of an image sensor. Further, it may be appreciated that optical flow sensing may—and often does—require focusing optics such as lenses, reflectors, and other optical elements in order to bring a near-field object into appropriate focus to facilitate optical flow sensing.

By contrast, speckle-flow sensing may not require transmit side (e.g., laser element) or receive side (e.g., imagining sensor) optics to encourage any particular focus configuration. Further, speckle sensing may be substantially agnostic to shifts along the axis separating the sensor from the skin surface, while exhibiting high sensitivity in the other two perpendicular axis. As a result of this benefit of speckle pattern sensing configurations, a processor of the relative position change sensor can be implemented in a simpler manner; detecting changes in only two axes is substantially computationally simpler than detecting changes in multiple axes, projecting into different vector spaces, and other potentially necessary or required conversion or translation operations. Further still, a speckle-based sensing system such as described herein can be substantially unaffected if a skin surface is disposed at an angle relative to the relative position change sensor.

Many embodiments described herein reference a head-mounted electronic device implemented with a form factor of eyeglasses or goggles. In each configuration, a display or projector can project an image that may be visible to at least one eye of the wearer. An eye tracking system may be used to determine an initial ground state relative position between the device and the wearer's anatomy, and thereafter, shifts or slips of the device relative to the wearer can be detected and reported by a relative position change sensor.

For example, a relative position change sensor may determine between a threshold number of frames (the duration of which may depend on a sampling rate of the image sensor of the relative position change sensor), the observed speckle pattern has shifted along a particular vector having a particular magnitude and direction. The relative position change sensor can be configured to compare the magnitude (and/or direction) of the vector against one or more thresholds to determine whether to report that a slippage event has occurred and/or whether a slippage event is likely ongoing and/or whether an inconsequential slippage or false positive has occurred. In some cases, the threshold may vary by direction and/or magnitude; a large change in a first direction may not satisfy the threshold whereas a small change in another direction may satisfy the threshold.

For example, the relative position change sensor may determine whether a first threshold is satisfied by the determined magnitude. In response to determining that the determined magnitude does satisfy the first threshold, the relative position change sensor may increase its frame rate to validate that a shift is occurring (e.g., selecting a different frame rate to increase sensing granularity or precision). Thereafter, further changes in the position of the speckle pattern can result in subsequent determinations of magnitude and direction, which again may be compared to a threshold such as a second threshold that is different from the first threshold, and corresponds to a greater displacement respectively associated with the first threshold. In response to determining that the second threshold is satisfied, the relative position change sensor may issue an instruction to a processor of the eye tracking system and/or the head-mounted electronic device itself to initiate another relative position detection operation with the higher-powered eye tracking system.

More simply, a relative position change sensor can be used to inform a series of escalating operational modes for a head-mounted electronic device. In a first mode, the relative position change sensor can be used to confirm that a relative position of the wearer and the head-mounted electronic device has not changed. In a second mode, the relative position change sensor can be used to enter a higher-power verification mode to confirm whether a slippage event of significant magnitude has occurred within a particular period of time. In a third mode, the relative position change sensor can be used to initiate a recalibration operation.

In some cases, a relative position change sensor as described herein can be used to adjust a calibration value or set of values associated with or describing a relative position of a wearer and a head-mounted electronic device as described herein. For example, if a relative position change sensor determines that a slippage event has occurred in which the device slipped 1 mm away from a wearer's eye and 1.5 mm down relative to the wearer's eye, an origin point or reference locating the position of the head-mounted electronic device relative to the wearer in a coordinate system may be adjusted along appropriate axes by 1 mm and 1.5 mm respectively. Thereafter, calculations based on the origin point may be based on the updated calibration value. In these examples, recalibration with an eye tracking system may not be required; the head-mounted electronic device can continue to operate as expected despite occurrence of a slippage event. The foregoing example is simplified; it may be appreciated generally and broadly that coordinate systems and/or origin points stored in a memory in respect of a wearer's anatomy and/or a device may be adjusted based on output of a relative position change sensor as described herein.

In some embodiments, a relative position change sensor can include multiple laser elements, which may operate simultaneously or independently. For example, in some cases, a first laser element may emit light at a first wavelength whereas a second laser element emits light at a second wavelength.

In some cases, a single head-mounted electronic device can include multiple relative position change sensors, disposed in multiple locations. For example, in some embodiments, a head-mounted electronic device can include two separately operable relative position change sensors positioned adjacent to each of two nose pads. The head-mounted electronic device can also include one or more relative position change sensors arranged and positioned to illuminate a temple region of the wearer. In some cases, the head-mounted electronic device can include a relative position change sensor oriented to illuminate a skin surface of the glabella. Each sensor in these examples can be independently operated. In other cases, each sensor can be cooperatively operated to produce a single determination of slippage. For example, output from a first relative position change sensor can be compared and/or combined with output from a second relative position change sensor. If both sensors agree that a slippage event has occurred, actions as described above may be initiated to recalibrate a device and/or apply a bias of a suitable magnitude to an existing calibration value. In other cases, if sensors do not agree that a slippage event has occurred, data from one or both sensors may be ignored.

As noted above, many relative position change sensors as described herein are configured to detect displacement along two orthogonal axes. Such embodiments can be additionally or alternatively configured to detect rotation along an axis orthogonal to both sensing axes. In some embodiments, a rotation event can be handle differently than a slippage event

In some cases, as noted above, a positive detection of a slippage event can trigger a number of actions such as biasing an existing position calibration value, triggering a recalibration operation, and so on. In other cases, direct feedback can be provided to a wearer of the head-mounted electronic device. For example, a notice may be rendered to instruct the wearer to adjust a position of the head-mounted electronic device. In other cases, detection of a slippage event may trigger an instruction to disable foveated rendering for a period of time. In other cases, detection of a slippage event may cause a sound or haptic feedback to be generated to encourage the wearer to adjust positioning of the head-mounted electronic device.

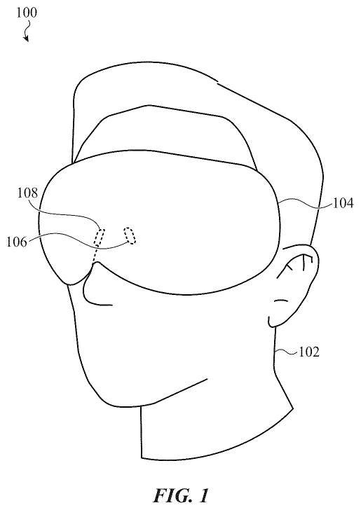

These foregoing and other embodiments are discussed below with reference to FIGS. 1-7. However, those skilled in the art will readily appreciate that the detailed description given herein with respect to these figures is for explanation only and should not be construed as limiting.

FIG. 1 depicts a user wearing a head-mounted electronic device that can incorporate a slippage sensing system as described herein.

In particular, FIG. 1 depicts a display system 100. The display system 100 can be configured to provide an extended reality experience for a wearer 102. As with other embodiments described herein, the extended reality experience can include virtual reality, mixed reality, and/or augmented reality. Regardless the level of immersion provided by the display system 100, the display system 100 can—generally and broadly—be configured to display images, objects, and/or content for the wearer 102.

The display system 100 includes a display device 104 that may be worn by the wearer 102. The display device 104 can include a frame, housing, or other enclosure formed in the general shape of goggles that cover the eyes of the wearer 102. The frame can likewise support one or more displays, optical elements, projectors, speakers, batteries, processors, memory, and one or more wireless or wired network communication modules that can cooperate to coordinate, perform, supervise, or monitor one or more operations of the display system 100 or, more specifically, the display device 104.

For example, in some embodiments the frame of the display device 104 can enclose a memory that stores computer readable instructions that, when executed by a processor also enclosed by the frame, instantiate an instance of software configured to leverage a display system within the frame to render for the wearer 102 one or more images. In some cases, the images may be eye specific in that an image rendered for the right eye of the wearer 102 may be different form an image rendered for the left eye of the wearer 102. In many cases, the images rendered for each eye are complementary to cooperatively define a perspective effect for the wearer 102.

In some embodiments, the display device 104 can be supported at least in part by anatomy of the wearer 102. For example, in the illustrated embodiment, the display device 104 can be configured with nose pads, such as the nose pad 106 and the nose pad 108 each positioned and configured to abut and engage with a side of the nasal bone of the wearer 102. In this manner, at least a portion of the mass or weight of the display device 104 may be supported by the nose of the wearer 102.

Although not depicted, it may be appreciated that the display device 104 can include other attachment mechanisms to engage with and attach to the head of the wearer 102. For example, in some embodiments, the frame of the display device 104 can include a strap around the head of the wearer 102.

The display system 100 can include an eye tracking system within the frame of the display device 104. The eye tracking system can be configured with one or more cameras and one or more illumination devices, such as infrared light emitting diodes. The eye tracking system can be disposed within the frame of the display device 104 and oriented toward the eyes of the wearer 102. As with other embodiments described herein, the eye tracking system can be leveraged by the display device 104 to inform rendering of images and/or objects shown to the wearer 102. For example, output of the eye tracking system can be used to inform foveated rendering decisions—namely which portion of which display should be rendered at a high frame rate and/or with high resolution and which portions of which display should be rendered a low frame rate and/or with low resolution.

During use, the display device 104 may slip down the nose of the wearer 102 due, in some cases, to weight of the display device 104. To detect such slippage events, the display device 104 can also include a relative position change sensor, such as described above. The relative position change sensor can be disposed within either or both the nose pad 106 or the nose pad 108, and oriented to emit laser light toward a portion of the skin covering the nasal bone. This laser illumination can result in a speckle pattern that can be imaged by an image sensor or imaging system of the relative position change sensor. The relative position change sensor can include a controller or processor that is configured to detect changes in the speckle pattern over time.

For example, in some embodiments, the image sensor of the relative position change sensor may be a complementary metal oxide semiconductor (CMOS) array. The CMOS array can include, as one example, sixty four pixels arranged in a square. Each of these pixels can be sampled by an analog frontend circuit of the relative position change sensor, which may include an analog to digital converter. For some constructions, the analog to digital converter may be configured to provide as output a representation of pixel brightness values as a value from 0.0 to 1.0, stored in a two dimensional array. In one example, a speckle pattern observed by the CMOS sensor may result in a data structure storing sixty four values, each corresponding to a digital representation of brightness observed by a particular pixel of the CMOS sensor. As a simplified example, an array of sixty four digital values that may represent an image captured of a speckle pattern by the CMOS sensor is provided below:
[0.0, 0.0, 0.0, 0.0, 0.0, 0.0, 0.0, 0.0,
0.0, 0.0, 0.0, 0.6, 0.6, 0.0, 0.0, 0.0,
0.0, 0.0, 0.9, 1.0, 0.9, 0.8, 0.0, 0.0,
0.0, 0.0, 0.5, 0.5, 0.4, 0.0, 0.0, 0.0,
0.0, 0.0, 0.0, 0.0, 0.0, 0.0, 0.0, 0.0,
0.0, 0.0, 0.0, 0.0, 0.0, 0.0, 0.0, 0.0,
0.0, 0.0, 0.0, 0.0, 0.0, 0.0, 0.0, 0.0,
0.0, 0.0, 0.0, 0.0, 0.0, 0.0, 0.0, 0.0]

A subsequent image/frame captured by the CMOS sensor may observe a shift in one or more of these values within the array. For example, a shift of two pixels to the right and down may be represented as:
[0.0, 0.0, 0.0, 0.0, 0.0, 0.0, 0.0, 0.0,
0.0, 0.0, 0.0, 0.0, 0.0, 0.0, 0.0, 0.0,
0.0, 0.0, 0.0, 0.0, 0.0, 0.0, 0.0, 0.0,
0.0, 0.0, 0.0, 0.0, 0.0, 0.6, 0.6, 0.0,
0.0, 0.0, 0.0, 0.0, 0.9, 1.0, 0.9, 0.8,
0.0, 0.0, 0.0, 0.0, 0.5, 0.5, 0.4, 0.0,
0.0, 0.0, 0.0, 0.0, 0.0, 0.0, 0.0, 0.0,
0.0, 0.0, 0.0, 0.0, 0.0, 0.0, 0.0, 0.0]

It may be appreciated that this foregoing example is simplified; in many actual implementations, a speckle pattern may influence detection of nonzero values of significantly all photosensitive regions of a CMOS sensor (or other image sensor type or topology).

Broadly, a relative position change sensor can be configured to detect a shift of pixel values between captured frames in a number of suitable ways. Independent of methodology, a relative position change sensor as described herein can be configured to determine, frame to frame, whether a change in position of a speckle pattern occurred and if so, what the magnitude of the observed change was.

As with other embodiments described herein, output of the relative position change sensor can be used to calibrate a relative position value representing the relative position (e.g., the origin points in a common coordinate space) of the wearer 102 and the display device 104. In other cases, output of the relative position change sensor can be used to trigger a recalculation/recalibration operation that is performed by another system, such as an eye tracking system.

These foregoing embodiments depicted in FIG. 1 and the various alternatives thereof and variations thereto are presented, generally, for purposes of explanation, and to facilitate an understanding of various configurations and constructions of a head-mounted device including a laser speckle flow sensor, such as described herein. However, it will be apparent to one skilled in the art that some of the specific details presented herein may not be required in order to practice a particular described embodiment, or an equivalent thereof.

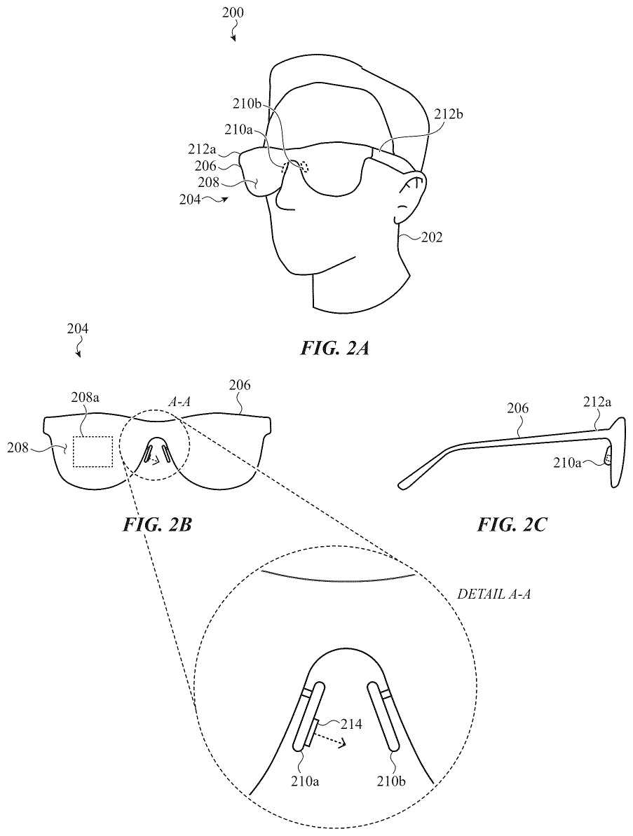

For example, it may be appreciated that a goggles are merely one possible form factor that a head-mounted electronic device as described herein may adopt. For example, FIGS. 2A-2B depict a user and a head-mounted electronic device that can incorporate a slippage sensing system as described herein. More specifically, FIG. 2A depicts a user wearing a head-mounted electronic device as described herein. FIG. 2B depicts a front plan view of the head-mounted electronic device of FIG. 2A, including a detail section A-A. Similarly, FIG. 2C depicts a side plan view of the head-mounted electronic device of FIGS. 2A-2B.

In these embodiments, the display system 200 includes a wearer 202 that may wear a display device 204. The display device 204 in this example embodiment can take the form factor of eyeglasses, but this is not required of all embodiments.

The display device 204 includes a frame 206. The frame 206 can be made of any number of suitable materials, including but not limited to plastics, acrylics, polymers, metal, ceramic, and the like. In other cases, organic materials such as wood may be suitable.

The frame 206 can be configured to enclose and support one or more operational components of the display device 204. For example, the frame 206 can enclose and support a processor, a memory, a wireless communication module (e.g., Wi-Fi, Bluetooth, cellular and the like), one or more haptic elements, one or more displays or projectors, and the like. These elements are omitted from FIG. 2A for illustrative simplicity, but it may be appreciated that such components can be disposed within the frame in a number of suitable distributions and locations.

The frame 206 can include a display region 208 positioned before and aligned with an eye of the wearer 202. In some cases, the frame 206 can include a single display region; in other embodiments the frame 206 can enclose and support at least two separate display regions, each associated with one eye of the wearer 202.

In the illustrated embodiment, the frame 206 may include a single display region configured to define display 208a. It is appreciated that this is merely one example; in other embodiments, multiple personal displays may be supported by the frame 206.

The display 208a can include a projector and projection surface and/or an emissive display such as a light emitting diode display or organic light emitting diode display. In other cases, the display may be a light filtering display such as a liquid crystal display without a backlight or sidelight.

As with other embodiments described herein, the display device 204 of the display system 200 can be supported at least in part by anatomy of the wearer 202. In this example, the display device 204 can include, as a portion of the frame 206, a nose pad 210a and a nose pad 210b. The frame 206 can also include one or more arms, such as the arm 212a or the arm 212b, that may be configured to rest over the upper portion of the wearer's ears. As a result of this configuration, when worn by the wearer 202, the nose pad 210a, the nose pad 210b, and the arms 212a, 212b each support a portion of the weight of the display device 204.

The display device 204 can also include a relative position change sensor as described herein. In particular, as noted above the relative position change sensor may be configured to detect flow of a speckle pattern to infer whether the display device 204 has slipped relative to the wearer 202. In the illustrated embodiment, the display device 204 includes the laser speckle flow sensor 214 within the nose pad 210a.

The laser speckle flow sensor 214 can include a laser emitter, an imaging system, and one or more circuits or processors configured to receive and modify output of the imaging system to produce an output corresponding to detected flow. For example, the laser speckle flow sensor 214 can be configured to provide a first digital value/output corresponding to a magnitude of detected slippage and a second digital value/output corresponding to a direction of detected slippage. In other cases, output of the laser speckle flow sensor 214 can be provided in another suitable form or format.

As shown in detail view A-A of FIG. 2B, the laser speckle flow sensor 214 is positioned within or adjacent to the nose pad 210a. This is merely one example configuration. In other cases, the laser speckle flow sensor 214 can be positioned along an upper portion of the nose pad 210a, along a middle portion of the nose pad 210a, or entirely within the nose pad 210a. As noted with respect to other embodiments described herein, the laser speckle flow sensor 214 may be positioned in plane with the nose pad 210a specifically so as to illuminate a portion of the anatomy of the wearer 202 that is unlikely to move relative to the display device 204 unless a slippage event has occurred.

These foregoing embodiments depicted in FIGS. 1-2B and the various alternatives thereof and variations thereto are presented, generally, for purposes of explanation, and to facilitate an understanding of various configurations and constructions of a head-mounted device including a laser speckle flow sensor, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, in other embodiments, a head-mounted electronic device can include multiple laser speckle flow sensors (also referred to herein as “relative position change sensors”). As one example, the embodiment shown in FIGS. 2A-2B may be configured to include multiple relative position change sensors disposed in different locations of the frame. A first sensor may be positioned with a first nose pad, a second sensor may be positioned relative to a second nose pad, and a third sensor may be positioned relative to the arm, so as to illuminate a temple of the wearer. Many constructions and configurations are possible.

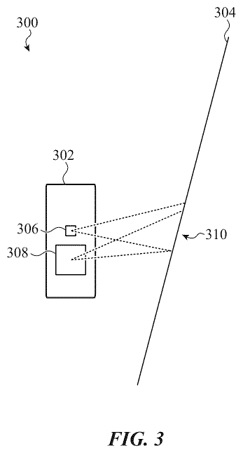

FIG. 3 is a simplified diagram of a slippage sensing system as described herein. The relative position change sensor 300 includes a laser speckle flow sensor 302 that can be positioned a distance from a target surface 304, which may be a skin surface of a wearer of a head-mounted electronic device as described herein. The target surface 304 may be selected as a surface that is not likely to move, shift, translate, or otherwise change position relative to the laser speckle flow sensor 302. As a result of this relative positioning, any detected change can be presumed to be (and/or otherwise considered to be) a true change in the relative position between the laser speckle flow sensor 302 and the target surface 304.

The laser speckle flow sensor 302 includes a laser element 306. The laser element 306 may be any suitable laser element configured to produce coherent laser light output. In some examples, the laser element 306 may be a laser diode, a vertical cavity surface emitting laser, or any other suitable laser device.

In many constructions, the laser element 306 may be configured to emit infrared light, but this is not required and in some embodiments may be configured to emit visible light.

The laser element 306 is described with respect to many embodiments herein as a single laser element, but this is not required of all embodiments. In some cases, the laser element 306 may be defined by an array of independent laser elements, such as an array of vertical cavity surface emitting lasers. In other constructions, a group of laser elements may each be configured to emit a different wavelength of light. Many constructions are possible.

The laser speckle flow sensor 302 also includes an imaging system 308. The imaging system 308 can be any suitable imaging system device, such as but not limited to CMOS sensors, SPAD arrays, photodiode arrays, or the like. For simplicity of illustration and description, the embodiments described herein reference configurations leveraging CMOS arrays, but it may be appreciated that this is merely one example.

The imaging system 308 is disposed within a module housing of the laser speckle flow sensor 302, and can be positioned below an optical aperture dedicated to the imaging system 308. In many cases, the imaging system 308 can be offset within the module housing of the laser speckle flow sensor 302 by a distance. As a result of the separation between the laser element 306 and the imaging system 308, each respective device may have a different field of view; namely, only a portion of the illuminated section of the target surface 304 may be reflected toward the imaging system 308. In these examples, a distance separating the laser speckle flow sensor 302 and the target surface 304 may be inferable based on the field of view overlap 310; the brighter an image received by the imaging system 308, the closer the laser speckle flow sensor 302 and the target surface 304 may be to one another. Such a calculation or estimate may not be required of all embodiments.

As noted above, monitoring speckle flow may provide several important advantages. For example, as speckle is a random interference pattern based on surface characteristics of a surface form which coherent light reflects, the pattern itself may be substantially independent (apart from slight changes in scale, which may not be readily observable at certain scales) of the distance separating the laser speckle flow sensor 302 and the target surface 304. Similarly, the pattern itself may be detectable independent of the relative angle between the laser speckle flow sensor 302 and the target surface 304. Therefore, as a result of independence from displacement or movement along at least one axis (horizontal axis of the page as illustrated), the laser speckle flow sensor 302 can operate with less complex and more performant hardware and software to monitor for two dimensional shifts relative to the target surface 304. More simply, by leveraging speckle flow, calculations for determining flow are simplified to two dimensions, which in turn can be calculated more simply than three-dimensional position tracking (e.g., certain optical flow tracking devices). This computational simplification resulting from dimensional complexity reduction can permit a processor associated with the laser speckle flow sensor 302 to operate at higher frame rates (or duty cycles) to sample significantly more rapidly than an eye tracking system could be configured to sample. In other operational modes, lower power consumption may be preferred. In these embodiments, the laser speckle flow sensor 302 may still be more performant than an eye tracking system in detecting slippage events.

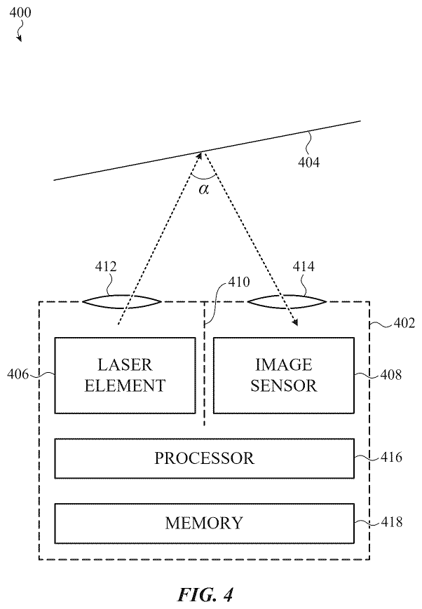

FIG. 4 is a system diagram of the slippage sensing system of FIG. 3. The system diagram 400 depicts the relative position change sensor 402 positioned apart from a target surface 404. The relative position change sensor 402 includes a laser element 406, which may be a vertical cavity surface emitting laser. The laser element 406 may be positioned and oriented to emit a coherent beam of laser light toward the target surface 404.

Surface characteristics of the target surface 404 may cause a random pattern of phase interference that results in a speckle pattern, some of which may be reflected back to an image sensor 408. The image sensor 408 may be a CMOS image sensor configured to capture a two-dimensional image of the speckle pattern at a configurable or fixed frame rate. As a result of this construction, the relative position change sensor 402 can be configured to leverage output of the image sensor 408 to measure shifts, relative to the plane of the image sensor 408 that can be correlated to a change in a relative position of the relative position change sensor 402 and the target surface 404.

The relative position change sensor 402 can also include a module housing, enclosure, or other structural member that supports one or more optional components such as an optional optical isolation barrier 410 (or other “separator”) separating the laser element 406 and the image sensor 408 so as to prevent and/or mitigate crosstalk between the two devices.

In other cases, the module housing can also support optical elements, which like the optional optical isolation barrier 410 may be optional and are not required in many embodiments. For example, in some embodiments, the relative position change sensor 402 includes the optional optics 412 and the optional optics 414, disposed over the laser element 406 and the image sensor 408 respectively. Example optical elements can include lenses, gratings, mirrors, reflective elements, and the like.

The relative position change sensor 402 also includes a processor, such as the processor 416. The processor 416 can be operationally and/or conductively coupled to the laser element 406, the image sensor 408 and to a memory 418. In some case, the processor 416 can be coupled to one or more drive circuits configured to apply a driving current to the laser element 406. The driving current may be a constant current signal, a variable current signal, a modulated current signal, or any other suitable drive signal.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements. Similarly, as described herein, the term “memory” refers to any software and/or hardware-implemented data storage device or circuit physically and/or structurally configured to store data in a non-transitory or otherwise nonvolatile, durable manner. This term is meant to encompass memory devices, memory device arrays (e.g., redundant arrays and/or distributed storage systems), electronic memory, magnetic memory, optical memory, and so on.

The processor 416 can be configured to operate with the image sensor 408 to calculate one or more speckle flow parameters, such as described herein. As one example, the processor 416 can be configured to analyze a sequence of frames to determine an average or pixel-specific flow vector predicting or characterizing changes therein between frames.

As noted above, the processor 416 can be configured to provide as output one or more digital values that corresponds to an observed speckle flow between two or more frames. In these examples, the processor 416 can cooperate with the memory 418 to store and/or buffer one or more values for retrieval or later access by a processor of an electronic device incorporating the relative position change sensor 402.

These foregoing embodiments depicted in FIGS. 3-4 and the various alternatives thereof and variations thereto are presented, generally, for purposes of explanation, and to facilitate an understanding of systems that incorporate a laser speckle flow sensor, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

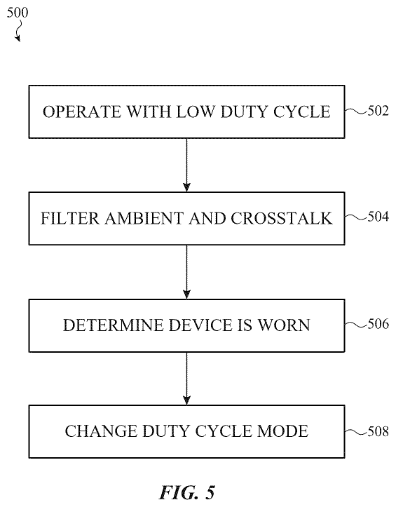

For example, in some embodiments a single relative position change sensor or laser speckle flow sensor can be configured to operate in one or more modes. FIG. 5 is a flowchart depicting example operations of a method of operating a slippage sensing system (e.g., a method of determining slippage) in a first mode, as described herein.

The method 500 may be performed in whole or in part by a processor associated with and/or operationally coupled to a relative position change sensor as described herein. The processor may be incorporated within the relative position change sensor or may be external to the relative position change sensor. In some cases, the method 500 can be performed in whole or in part by cooperation of one or more processors, such as a processor of a relative position change sensor and a processor of a head-mounted electronic device incorporating the relative position change sensor.

The method 500 includes operation 502 at which the relative position change sensor may be configured to operate at a low duty cycle (e.g., a first duty cycle). In these examples, a laser element may be configured to emit light only during certain intervals and/or for certain periods of time. Likewise, an imaging sensor may be configured to capture images/frames in respect of speckle patterns at a given frame rate. In some examples, an example frame rate may be sixty frames per second. In other cases, ten frames per second may be suitable. In yet other cases, fewer or more frames per second may be suitable. Different frame rates can be selected in different configurations.

The method 500 includes operation 504 at which one or more prefiltering operations can be performed against data output by an image sensor of a relative position change sensor as described herein. For example, dark pixel subtraction, calibration values and/or cross talk mitigation operations can be performed to condition otherwise raw data output from an image sensor. In other cases, image modification operations can be performed such as contrast enhancements or brightness scaling operations.

Thereafter, operation 506 can determine that a movement or nonzero flow has occurred and satisfied a threshold. In this example, nonzero flow can trigger an indication to the head-mounted electronic device or another electronic device that the head-mounted electronic device has been positioned/placed on a wearer. More broadly, operations 502 through 506 may be leveraged to determine whether the head-mounted electronic device has been initially worn by a user. Finally, after having determined that the device is being worn, at operation 508, the relative position change sensor can enter a secondary mode that is associated with a higher duty cycle and/or a faster frame/sampling rate. As an example the sampling rate/duty cycle associated with operation 502 may be five frames per second or fewer, whereas the higher frame rate associated with operation 508 may be

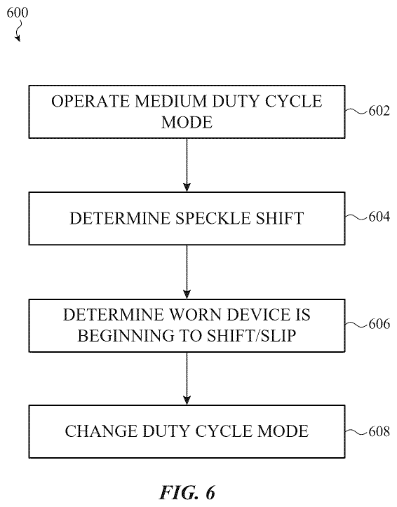

FIG. 6 is a flowchart depicting example operations of a method of operating a slippage sensing system in a second mode, as described herein.

As with the method 500 described in respect of FIG. 5, the method 600 may be performed in whole or in part by a processor associated with and/or operationally coupled to a relative position change sensor as described herein. The processor may be incorporated within the relative position change sensor or may be external to the relative position change sensor. In some cases, the method 600 can be performed in whole or in part by cooperation of one or more processors, such as a processor of a relative position change sensor and a processor of a head-mounted electronic device incorporating the relative position change sensor.

The method 600 includes operation 602 at which a relative position change sensor is operated with a medium duty cycle (e.g., a second duty cycle greater than the first duty cycle associated with operation 502 of the method 500 as described with respect to FIG. 5). Next at operation 604, it may be determined by operation of the relative position change sensor that a received speckle has shifted by at least a threshold amount. Next at operation 606, it may be determined—based on satisfying a threshold amount of shift—that a slippage event (or device shift event) has begun. Finally, at operation 608, the device may change a duty cycle mode, such as by entering a higher-power and higher-frame rate operational mode. In this manner, the method 600 can serve to coarsely detect and/or measure slippage, while operating at reduced power relative to an eye tracking system or the like.

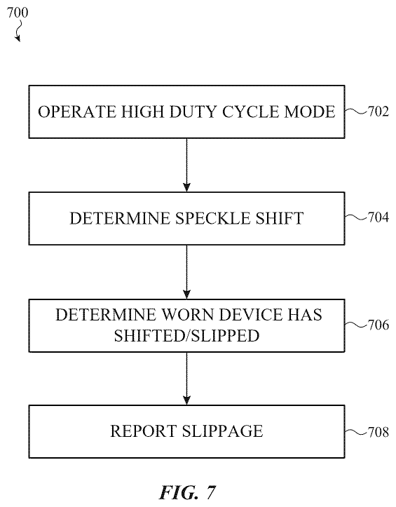

FIG. 7 is a flowchart depicting example operations of a method of operating a slippage sensing system in a third mode, as described herein. The method 700 includes operation 702 at which a relative position change sensor operates at a high duty cycle (e.g., a third duty cycle, which may be greater than the second duty cycle of operation 602 of method 600 described in respect of FIG. 6). At operation 704, further shift—in addition to that which may have been recognized by virtue of executing the method described in reference to FIG. 6—may be recognized and it may be determined that the subsequent shift or continuing shift exceeds another threshold. Next at operation 706, it may be determined that the head-mounted electronic device has slipped relative to a wearer thereof. Finally, at operation 708, the detected slip may be reported to a processor of the head-mounted electronic device to (1) trigger a re-calibration operation with an eye tracking system or (2) generate and/or display a request for the wearer to adjust position of the device. The detected slip may be reported as a magnitude of displacement between series/sequences of frames, a binary indication that a slippage has occurred, or any other suitable indication of slippage. In this manner, the method 700 can serve to finely detect and/or measure slippage, while still operating at reduced power relative to an eye tracking system or the like.

These foregoing embodiments depicted in FIGS. 5-7 and the various alternatives thereof and variations thereto are presented, generally, for purposes of explanation, and to facilitate an understanding of methods of operating a laser speckle flow sensor, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings. For example, in some embodiments, the methods of FIGS. 5-7 can be executed in sequence. Upon execution of the method 500, the method 600 can be executed, to be followed by the method 700 and so on.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more other embodiments, whether or not such embodiments are described and whether or not such features are presented as being a part of a described embodiment. Thus, the breadth and scope of the present description should not be limited by any of the above-described exemplary embodiments.

What is claimed is:

1. A head-mounted electronic device comprising:
a frame comprising a nose pad configured to rest on a skin surface of a nasal bone of a wearer; and
a relative position change sensor disposed at least partially within the nose pad, and oriented, when the head-mounted electronic device is worn by the wearer, toward the skin surface, the relative position change sensor comprising:
a laser element configured to emit coherent laser light toward the skin surface;
an image sensor offset from the laser element and oriented to capture a first frame and a second frame of a speckle pattern resulting from illumination of the skin surface by the laser element; and
a processor operably coupled to the image sensor and configured to report slippage of the head-mounted electronic device relative to the wearer in response to a detected shift of the speckle pattern between the first frame and the second frame.

2. The head-mounted electronic device of claim 1, wherein:
the processor is a first processor and is configured to determine that the detected shift of the speckle pattern satisfies a threshold;
the head-mounted electronic device further comprises a second processor; and
the first processor is configured to signal slippage of the head-mounted electronic device to the second processor.

3. The head-mounted electronic device of claim 1, wherein the relative position change sensor comprises a separator between the laser element and the image sensor.

4. The head-mounted electronic device of claim 1, wherein the laser element is a vertical cavity surface emitting laser.

5. The head-mounted electronic device of claim 1, wherein the image sensor is a complementary metal oxide semiconductor image sensor.

6. The head-mounted electronic device of claim 1, further comprising an optical element positioned over at least one of the laser element or the image sensor.

7. The head-mounted electronic device of claim 1, wherein the image sensor is configured to capture a sequence of frames and the processor is configured to determine flow of the speckle pattern between each frame.

8. The head-mounted electronic device of claim 1, wherein the processor is configured to provide as output:
a first digital value corresponding to a magnitude of detected shift; and
a second digital value corresponding to a direction of detected shift.

9. A head-mounted electronic device comprising:
a frame configured to be worn by a wearer; and
a relative position change sensor configured to be oriented, when the head-mounted electronic device is worn by the wearer, toward a skin surface of the wearer, the relative position change sensor comprising:
a laser element configured to emit coherent laser light toward the skin surface;
an image sensor offset from the laser element and configured to image a speckle pattern resulting from illumination of the skin surface by the laser element; and
a processor operably coupled to the image sensor and configured to signal slippage of the head-mounted electronic device relative to the wearer in response detecting a shift of the speckle pattern that exceeds a threshold.

10. The head-mounted electronic device of claim 9, wherein the relative position change sensor is disposed adjacent to a nose pad of the frame.

11. The head-mounted electronic device of claim 9, wherein:
the relative position change sensor is a first relative position change sensor;
the head-mounted electronic device further comprises a second relative position change sensor; and
each of the first and second relative position change sensors are disposed to illuminate the skin surface.

12. The head-mounted electronic device of claim 11, wherein the skin surface is associated with a glabella or a nasal bone of the wearer.

13. The head-mounted electronic device of claim 9, wherein the processor is configured to monitor flow of the speckle pattern over time.

14. The head-mounted electronic device of claim 9, wherein the laser element emits infrared light.

15. The head-mounted electronic device of claim 9, wherein an output of the relative position change sensor is used to modify a calibration value of the head-mounted electronic device that corresponds to a relative position between the wearer and the head-mounted electronic device.

16. A method of determining slippage of a worn head-mounted electronic device, the method comprising:
emitting, with a laser element, coherent laser light toward a skin surface of a wearer of the head-mounted electronic device;
operating an image sensor to capture a sequence of frames of a speckle pattern resulting from illumination of the skin surface by the laser element;
determining a change over time of at least one pixel of at least one frame of the series of frames captured by the image sensor;
determining whether the change satisfies a threshold; and
in accordance with a determination that the change does satisfy the threshold, signaling a processor of the worn head-mounted electronic device that slippage has occurred.

17. The method of claim 16, wherein the laser element and the image sensor are disposed within a nose pad of the head-mounted electronic device that rests, when worn by the wearer, over a side of a nasal bone of the wearer.

18. The method of claim 16, wherein the image sensor is configured to capture the sequence of frames at a selected frame rate.

19. The method of claim 18, wherein the selected frame rate is selected based upon an operational mode of the image sensor.

20. The method of claim 16, wherein the change comprises a magnitude and direction of shift.
